(19) United States
(12) Patent Application Publication
(10) Pub. No.: US 2023/0220629 A1
(43) Pub. Date: Jul. 13, 2023

(54) A METHOD FOR MANUFACTURING A FOAM COATED CELLULOSE BASED SUBSTRATE

(71) Applicant: Stora Enso OYJ, Helsinki (FI)

(72) Inventors: Isto Heiskanen, Imatra (FI); Katja Lyytikäinen, Imatra (FI); Kaj Backfolk, Lappeenranta (FI)

(73) Assignee: Stora Enso OYJ, Helsinki (FI)

(21) Appl. No.: 17/999,221

(22) PCT Filed: May 19, 2021
(86) PCT No.: PCT/IB2021/054301

§ 371 Date: Nov. 18, 2022

(30) Foreign Application Priority Data
May 20, 2020 (SE) 2050594-7

(51) Int. Cl. D21H 21/56; D21H 19/20; D21H 17/36; D21H 11/18

(52) U.S. Cl. CPC D21H 21/56; D21H 19/20; D21H 17/36; D21H 11/18

(57) ABSTRACT

The present invention relates to a method for manufacturing a polymer coated cellulose based substrate useful as a barrier film, said method comprising the steps of: a) providing a cellulose based substrate comprising 50-99 wt % highly refined cellulose fibers based on the total dry weight of the cellulose based substrate; b) preparing an aqueous foam from an aqueous solution of a foam forming polymer; c) applying the aqueous foam to at least one surface of the cellulose based substrate; and d) collapsing the aqueous foam to form a polymer coating on the cellulose based substrate.

### TECHNICAL FIELD

The present disclosure relates to gas barrier films for paper and paperboard based packaging materials. More specifically, the present disclosure relates to gas barrier films based on microfibrillated cellulose having a good and stable oxygen and water vapor barrier properties. The present invention further relates to paper and paperboard based packaging materials comprising such barrier films and to methods for manufacturing such barrier films.

### BACKGROUND

Coating of paper and paperboard with plastics is often employed to combine the mechanical properties of the paperboard with the barrier and sealing properties of a plastic film. Paperboard provided with even a relatively small amount of a suitable plastic material can provide the properties needed to make the paperboard suitable for many demanding applications, for example as liquid packaging board. In many cases however, the gas barrier properties of the polymer coated paperboard are still insufficient. Therefore, in order to ensure acceptable gas barrier properties the polymer coated paperboard is often provided with one or more layers of aluminum foil. However, due to its high carbon footprint there is a wish to replace aluminum foils in packaging materials in general, and in liquid packaging board in particular.

More recently, microfibrillated cellulose (MFC) films have been developed, in which defibrillated cellulosic fibrils have been suspended e.g. in water, re-organized and rebonded together to form a continuous film. MFC films have been found to provide good gas barrier properties as well as good resistance to grease and oil. Unfortunately, the gas barrier properties of such MFC films tend to deteriorate at high temperatures and high humidity.

Many approaches for improving the gas barrier properties towards oxygen, air, and aromas at high relative humidity have been investigated and described, but most of the suggested solutions involving chemical modification or polymer coating are expensive and difficult to implement in industrial scale.

Furthermore, manufacturing of films and barrier substrates from MFC and other highly refined cellulose furnishes with very slow drainage is difficult on a paper machine since it is difficult to create good barriers due to occurrence of pinholes. Pinholes are microscopic holes that can appear in the web during the forming process. Examples of reasons for the appearance of pinholes include irregularities in the pulp suspension, e.g. formed by flocculation or re-flocculation of fibrils, rough dewatering fabric, uneven pulp distribution on the wire, or too low a web grammage. Pinhole formation typically increases with increased dewatering speed. However, in pinhole free areas, the Oxygen Transmission Rate (OTR) value is generally good when grammage is in the range of 20-40 g/m².

One approach to improve barrier properties has been to make a thin base substrate, which comprises some pinholes, and then to coat the substrate with a polymeric coating composition. This approach, however, requires a coating concept and a coating formulation that is optimized in terms of surface filling and simultaneously providing barrier. Coating of a thin web is also challenging since the coating may cause web breaks. The number of times a substrate is rewetted and dried, should also be kept to a minimum since each additional step adds costs. Polymeric coatings may also reduce the repulpability of the film and thereby the recyclability of products comprising the film.

Thus, there remains a need for improved cellulose based barrier films that provide good gas barrier properties and good resistance to grease and oil even under humid conditions. Furthermore, the cellulose based barrier films should preferably be capable of being efficiently manufactured on a paper machine.

### DESCRIPTION OF THE INVENTION

It is an object of the present disclosure to provide a method for manufacturing a cellulose based barrier film comprising highly refined cellulose fibers, such as microfibrillated cellulose (MFC), which alleviates at least some of the above mentioned problems associated with prior art methods.

It is a further object of the present disclosure to provide an improved method for manufacturing a coated cellulose based substrate comprising highly refined cellulose fibers in a paper or paperboard machine type of process.

It is a further object of the present disclosure to provide a cellulose based barrier film useful as gas barrier in a paper or paperboard based packaging material with high repulpability, providing for high recyclability of packaging products comprising the film.

The above-mentioned objects, as well as other objects as will be realized by the skilled person in the light of the present disclosure, are achieved by the various aspects of the present disclosure.

According to a first aspect illustrated herein, there is provided a method for manufacturing a polymer coated cellulose based substrate useful as a barrier film, said method comprising the steps of:
a) providing a cellulose based substrate comprising 50-99 wt % highly refined cellulose fibers based on the total dry weight of the cellulose based substrate;
b) preparing an aqueous foam from an aqueous solution of a foam forming polymer;
c) applying the aqueous foam to at least one surface of the cellulose based substrate; and
d) collapsing the aqueous foam to form a polymer coating on the cellulose based substrate.

The inventive method provides a polymer coated cellulose based substrate which combines good gas, water vapor and grease barrier properties and is useful as a barrier film e.g. in food packaging applications. In addition, the foam coating of the inventive method allows for the polymer coated cellulose based substrate to be efficiently manufactured on a paper machine.

The present inventors have found that with the foam coating of the inventive method the gas barrier properties of a cellulose based substrate can be significantly improved, even when the foam is applied at very low grammages, such as a grammage below 5 g/m² based on the total dry weight of the coating. With the foam coating of the inventive method, also lower quality cellulose based substrates having a higher porosity due to the amount and size of pin-holes, can be used for preparing barrier films.

The inventive method allows for manufacturing a polymer coated cellulose based substrate comprising highly refined cellulose fibers in a paper machine type of process. The foam coating has been found to decrease the risk of web breaks compared to conventional coating methods, such as curtain coating, blade coating, etc. This is believed to be due to lower water penetration/rewetting of the substrate during foam coating than during conventional liquid coating. The foam coating step can also be conveniently introduced in existing paper machines and processes.

The polymer coated cellulose based substrate can be used to replace conventional barrier films, such as synthetic polymer films which reduce the recyclability of paper or paperboard packaging products. Thanks to the low coat weight of the foam coated polymer, the inventive polymer coated cellulose based substrate has high repulpability, providing for high recyclability of the films and paper or paperboard packaging products comprising the polymer coated substrate.

The inventive method uses a cellulose based substrate comprising highly refined cellulose fibers. Refining, or beating, of cellulose pulps refers to mechanical treatment and modification of the cellulose fibers in order to provide them with desired properties. The highly refined cellulose fibers can be produced from different raw materials, for example softwood pulp or hardwood pulp. The highly refined cellulose fibers are preferably never dried cellulose fibers.

The cellulose based substrate comprises 50-99 wt % highly refined cellulose fibers based on the total dry weight of the cellulose based substrate. In some embodiments, the cellulose based substrate comprises 70-99 wt %, preferably 80-99 wt %, highly refined cellulose fibers based on the total dry weight of the cellulose based substrate.

Because of the content of highly refined cellulose fibers, the cellulose based substrate will typically have a density above 600 kg/m³, preferably above 900 kg/m³. Such substrates have been found to be very useful as gas barrier films, e.g. in packaging applications.

The term highly refined cellulose fibers as used herein preferably refers to refined cellulose fibers having a Schopper-Riegler (SR) value of 65 or higher, preferably 70 or higher, as determined by standard ISO 5267-1.

In some embodiments, the cellulose based substrate is formed from a cellulose furnish having a Schopper-Riegler (SR) value in the range of 70-99, preferably in the range of 70-90.

The dry solids content of the cellulose based substrate may be comprised solely of the highly refined cellulose fibers, or it can comprise a mixture of highly refined cellulose fibers and other ingredients or additives. The cellulose based substrate preferably includes highly refined cellulose fibers as its main component based on the total dry weight of the substrate. The cellulose based substrate comprises at least 50 wt %, preferably at least 70 wt %, more preferably at least 80 wt % or at least 90 wt % of highly refined cellulose fibers, based on the total dry weight of the substrate.

In some embodiments, the highly refined cellulose fibers of the cellulose based substrate is refined kraft pulp. Refined kraft pulp will typically comprise at least 10% hemicelluloses. Thus, in some embodiments the cellulose based substrate comprises hemicelluloses at an amount of at least 10%, such as in the range of 10-25%, of the amount of the highly refined cellulose fibers.

The cellulose based substrate may further comprise additives such as native starch or starch derivatives, cellulose derivatives such as sodium carboxymethyl cellulose, a filler, retention and/or drainage chemicals, flocculation additives, deflocculating additives, dry strength additives, softeners, cross-linking aids, sizing chemicals, dyes and colorants, wet strength resins, fixatives, de-foaming aids, microbe and slime control aids, or mixtures thereof. The cellulose based substrate may further comprise additives that will improve different properties of the mixture and/or the produced film such as latex and/or polyvinyl alcohol (PVOH) for enhancing the ductility of the film.

The inventive method is especially useful for cellulose based substrates of so called microfibrillated cellulose (MFC). Thus, in some embodiments the highly refined cellulose fibers is MFC.

Microfibrillated cellulose (MFC) shall in the context of the patent application be understood to mean a nano scale cellulose particle fiber or fibril with at least one dimension less than 1000 nm. MFC comprises partly or totally fibrillated cellulose or lignocellulose fibers. The liberated fibrils have a diameter less than 1000 nm, whereas the actual fibril diameter or particle size distribution and/or aspect ratio (length/width) depends on the source and the manufacturing methods. The smallest fibril is called elementary fibril and has a diameter of approximately 2-4 nm (see e.g. Chinga-Carrasco, G., Cellulose fibres, nanofibrils and microfibrils, The morphological sequence of MFC components from a plant physiology and fibre technology point of view, Nanoscale research letters 2011, 6:417), while it is common that the aggregated form of the elementary fibrils, also defined as microfibril (Fengel, D., Ultrastructural behavior of cell wall polysaccharides, Tappi J., March 1970, Vol 53, No. 3.), is the main product that is obtained when making MFC e.g. by using an extended refining process or pressure-drop disintegration process. Depending on the source and the manufacturing process, the length of the fibrils can vary from around 1 to more than 10 micrometers. A coarse MFC grade might contain a substantial fraction of fibrillated fibers, i.e. protruding fibrils from the tracheid (cellulose fiber), and with a certain amount of fibrils liberated from the tracheid (cellulose fiber).

There are different names used for MFC, such as cellulose microfibrils, fibrillated cellulose, nanofibrillated cellulose, fibril aggregates, nanoscale cellulose fibrils, cellulose nanofibers, cellulose nanofibrils, cellulose microfibers, cellulose fibrils, microfibrillar cellulose, microfibril aggregates and cellulose microfibril aggregates. MFC can also be characterized by various physical or physical-chemical properties such as its large surface area or its ability to form a gel-like material at low solids (1-5 wt %) when dispersed in water.

Various methods exist to make MFC, such as single or multiple pass refining, pre-hydrolysis followed by refining or high shear disintegration or liberation of fibrils. One or several pre-treatment steps are usually required in order to make MFC manufacturing both energy efficient and sustainable. The cellulose fibers of the pulp to be utilized may thus be pre-treated, for example enzymatically or chemically, to hydrolyse or swell the fibers or to reduce the quantity of hemicellulose or lignin. The cellulose fibers may be chemically modified before fibrillation, such that the cellulose molecules contain other (or more) functional groups than found in the native cellulose. Such groups include, among others, carboxymethyl (CMC), aldehyde and/or carboxyl groups (cellulose obtained by N-oxyl mediated oxidation, for example “TEMPO”), quaternary ammonium (cationic cellulose) or phosphoryl groups. After being modified or oxidized in one of the above-described methods, it is easier to disintegrate the fibers into MFC or nanofibrils.

The nanofibrillar cellulose may contain some hemicelluloses, the amount of which is dependent on the plant source. Mechanical disintegration of the pre-treated fibers, e.g. hydrolysed, pre-swelled, or oxidized cellulose raw material is carried out with suitable equipment such as a refiner, grinder, homogenizer, colloider, friction grinder, ultrasound sonicator, fluidizer such as microfluidizer, macrofluidizer or fluidizer-type homogenizer. Depending on the MFC manufacturing method, the product might also contain fines, or nanocrystalline cellulose, or other chemicals present in wood fibers or in papermaking process. The product might also contain various amounts of micron size fiber particles that have not been efficiently fibrillated.

MFC is produced from wood cellulose fibers, both from hardwood and softwood fibers. It can also be made from microbial sources, agricultural fibers such as wheat straw pulp, bamboo, bagasse, or other non-wood fiber sources. It is preferably made from pulp including pulp from virgin fiber, e.g. mechanical, chemical and/or thermomechanical pulps. It can also be made from broke or recycled paper.

The cellulose based substrate may be comprised solely of MFC, or it can comprise a mixture of MFC and other ingredients or additives. The cellulose based substrate preferably includes MFC as its main component based on the total dry weight of the cellulose based substrate. In some embodiments, the cellulose based substrate comprises 50-99 wt %, preferably at least 70-99 wt %, more preferably at least 80-99 wt % MFC, based on the total dry weight of the cellulose based substrate.

In some embodiments, at least some of the MFC is obtained from MFC broke. MFC broke refers to reject, e.g. trimmings and other scrap, obtained from a process for making a product comprising high content of MFC.

In addition to the highly refined cellulose fibers, the cellulose based substrate may also comprise a certain amount of unrefined or slightly refined cellulose fibers. The term unrefined or slightly refined fibers as used herein preferably refers to cellulose fibers having a Schopper-Riegler (SR) value below 30, preferably below 28, as determined by standard ISO 5267-1. Unrefined or slightly refined cellulose fibers are useful to enhance dewatering and may also improve strength and fracture toughness of the cellulose based substrate. In some embodiments, the cellulose based substrate comprises less than 50 wt %, preferably less than 30 wt %, and more preferably less than 10 wt % of unrefined or slightly refined cellulose fibers, based on the total dry weight of the cellulose based substrate. In some embodiments, the cellulose based substrate comprises 0.1-50 wt %, preferably 0.1-30 wt %, and more preferably 0.1-10 wt % of unrefined or slightly refined cellulose fibers, based on the total dry weight of the cellulose based substrate. The unrefined or slightly refined cellulose fibers may for example be obtained from bleached or unbleached or mechanical or chemimechanical pulp or other high yield pulps. The unrefined or slightly refined cellulose fibers are preferably never dried cellulose fibers.

The grammage of the cellulose based substrate is preferably selected to provide a combination of adequate mechanical strength and barrier properties. In some embodiments, the basis weight of the cellulose based substrate is in the range of 10-100 g/m². The foam coating of the inventive method advantageously allows for thinner cellulose based substrates to be used. Thus, in some embodiments the basis weight of the cellulose based substrate is less than 55 g/m², preferably in the range of 10-50 g/m², more preferably in the range of 10-30 g/m².

The inventive method comprises preparing an aqueous foam from an aqueous solution of a foam forming polymer. A foam may be prepared by incorporating a significant amount of gas, typically air, in a liquid, typically aqueous, solution or suspension.

The terms foam and foamed, as used herein, refers to a substance made by trapping air or gas bubbles inside a solid or liquid. Typically, the volume of gas is much larger than that of the liquid or solid, with thin films separating gas pockets. Three requirements must be met in order for foam to form. Mechanical work is needed to increase the surface area. This can occur by agitation, dispersing a large volume of gas into a liquid, or injecting a gas into a liquid. The second requirement is that a foam forming agent, typically an amphiphilic substance, a surfactant or surface active component, must be present to decrease surface tension. Finally, the foam must form more quickly than it breaks down.

To enable foaming of the aqueous solution, the aqueous solution comprises a foam forming polymer as a foaming agent. Besides acting as a foaming agent, the foam forming polymer should preferably also be capable of forming a polymeric barrier film on the cellulose based substrate. Thus, in preferred embodiments the foam forming polymer acts both as a foaming agent and as a barrier film forming polymer. In other words, the foam forming polymer is preferably a foam and film forming polymer.

The foam forming polymer is preferably an amphiphilic polymer, i.e. a polymer comprising both hydrophilic parts and hydrophobic parts. In some embodiments, the amphiphilic polymer is selected from the group consisting of optionally hydrophobically modified polysaccharides (typically starch or cellulose derivatives), proteins, polyvinyl alcohol (PVOH), partially hydrolyzed polyvinyl acetate (PVOH/Ac), and mixtures thereof. The optional hydrophobic modification typically comprises one or more hydrophobic groups, e.g. alkyl groups, covalently attached to the foam forming polymer.

In some embodiments, the foam forming polymer is selected from the group consisting of a polyvinyl alcohol (PVOH), a partially hydrolyzed polyvinyl acetate (PVOH/Ac), and an octenyl succinic anhydride starch (OSA starch).

In some embodiments, the foam forming polymer is a polyvinyl alcohol (PVOH) or an octenyl succinic anhydride starch (OSA starch).

In some embodiments, the foam forming polymer is a polyvinyl alcohol (PVOH).

In some embodiments, the foam forming polymer is lignin or a lignin derivative, preferably lignin.

In some embodiments, the foam forming polymer has a molecular weight above 5 000 g/mol, preferably above 10 000 g/mol. An advantage of using a polymer as the foaming agent is that they are inherently less prone to migration from the finished product than low molecular weight surfactants or tensides.

The aqueous solution, aqueous foam, and finished polymer coating are preferably free from low molecular weight surfactants or tensides that may migrate from the material. In some embodiments the aqueous solution, aqueous foam, and finished polymer coating are free from surface active chemicals having a molecular weight below 1 000 g/mol.

The aqueous solution, aqueous foam, and finished polymer coating may further comprise various additives that will improve different properties of the aqueous solution, aqueous foam, and finished polymer coating. Examples of additives include, but are not limited to rheology modifiers, humectants, softeners, nanofibers, nanofillers, and cross-linking agents.

The additives are typically present at an amount of less than 10 wt % based on the total dry weight of the aqueous solution, aqueous foam, or finished polymer coating.

In some embodiments, the aqueous foam further comprises a cross-linking agent capable of cross-linking the foam forming polymer. Examples of possible cross-linking agents include, but are not limited to, citric acid or sodium trimetaphosphate (STMP).

A foam may be prepared by incorporating a significant amount of gas, typically air, in a liquid, typically aqueous, solution or suspension. The foaming can for example be achieved using a foam generator. The solution or suspension may be pumped through a foam generator one or several times in order to reach a desired gas content or foam density. Foam can be generated either offline or inline at the paper machine. The air content of the aqueous foam is typically in the range of 40-90% by volume. Depending on the composition and foam generator, different bubble sizes can be created. Mean radius of the bubbles is preferably above 20 μm, such as in the range of 20-2000 μm. The foaming reduces the density of the aqueous solution as compared to an unfoamed aqueous solution. Thus, in some embodiments the density of the aqueous foam is less than 0.8 g/cm³, preferably less than 0.6 g/cm³, more preferably less than 0.4 g/cm³. In some embodiments, the aqueous foam has a viscosity in the range of 800-3500 mPas.

In some embodiments, the aqueous foam is prepared from an aqueous solution of the foam forming polymer comprising at least 5 wt %, preferably at least 8 wt %, and more preferably at least 10 wt % of the foam forming polymer, based on the total weight of the aqueous solution.

The pH of the aqueous foam is typically in the range of 4-10, and preferably in the range of 6-8. The temperature of the aqueous foam is preferably kept constant and preferably below 60° C.

The aqueous foam is applied as a coating layer on the cellulose based substrate. In some embodiments, the aqueous foam is applied by a non-contact application method. Application may for example be made using a headbox or a curtain coating arrangement.

The cellulose-based substrate is preferably dry when the aqueous foam is applied. The term “dry” as used herein means that the cellulose-based substrate has a dry content above 80%, preferably above 90%, and more preferably above 95% by weight.

The thickness of the applied aqueous foam is significantly higher than the thickness of a conventional non-foamed coating. In some embodiments, the initial thickness of the applied aqueous foam, before the foam is collapsed, is at least 1 mm.

The foam applied to the cellulose based substrate is collapsed in order to form the polymer coating. The term “collapsing” as used herein refers to the processes where gas bubbles of the foam rupture and the gas content of the foam decreases, e.g. due to drainage, coalescence and disproportiation. The aqueous foam begins to collapse as soon as it is applied on the cellulose based substrate, e.g. due to drainage of water through the cellulose based substrate and the wire. The collapse may preferably be accelerated by application of force, e.g. in the form of one or more rods, rolls or blades. The amount of entrapped gas in the aqueous foam will typically decrease significantly as the coated substrate is processed. In some embodiments, the polymer coating formed on the cellulose based substrate is free from, or substantially free from gas bubbles remaining from the aqueous foam.

The foam collapse may advantageously be accelerated such that the polymer coating is formed more quickly.

In some embodiments, the foam collapse is accelerated by mechanical force applied to the foam. In some embodiments, the foam collapse is accelerated by force applied to the foam by one or more rods, rolls or blades. The rods, rolls or blades may be conventional rods, rolls or blades used in coating processes.

Further measures for accelerating the foam collapse typically involve drying the aqueous foam. In some embodiments, the drying comprises subjecting the aqueous foam to heating, reduced pressure, or a combination thereof.

In a preferred embodiment, the foam collapse is accelerated by first applying mechanical force to the foam, and then subjecting the aqueous foam to heating, reduced pressure, or a combination thereof. In a further preferred embodiment, the foam collapse is accelerated by first applying mechanical force to the foam using a rod, and then subjecting the aqueous foam to heating using infrared radiation.

In some embodiments, the cellulose based substrate is heated before the aqueous foam is applied. Heating the cellulose based substrate before the aqueous foam is applied causes an increased evaporation of the water in the foam closest to the substrate surface. This can reduce the rewetting of the cellulose based substrate and prevent web breaks. In some embodiments, the cellulose based substrate is heated to a temperature in the range of 40-115° C., preferably to 50-90° C., and more preferably to 60-85° C., before the aqueous foam is applied.

In some embodiments, the cellulose based substrate with the applied aqueous foam is heated. The heating may for example be effected using radiation or steam heating.

The foam collapse may also be accelerated by pressing the polymer coated cellulose based substrate in a pressing arrangement to force remaining bubbles to leave the polymer coating.

As a result of the collapsing of the aqueous foam, the obtained dry polymer coating is preferably non-porous, or substantially non-porous.

In some embodiments, the method further comprises the step e) subjecting the foam forming polymer of the collapsed aqueous foam to crosslinking.

The crosslinking may preferably be effected using a cross-linking agent present in the aqueous foam. The crosslinking should preferably be performed after the aqueous foam has been collapsed.

The present inventors have found that with the foam coating of the inventive method the gas barrier properties of a cellulose based substrate can be significantly improved, even when the foam is applied at very low grammages, such as a grammage below 5 g/m² based on the total dry weight of the coating. Thus, in some embodiments the basis weight of the polymer coating is less than 10 g/m², preferably less than 5 g/m². Thanks to the low coat weight of the foam coated polymer, the inventive polymer coated cellulose based substrate may still have high repulpability, providing for high recyclability of the films and paper or paperboard packaging products comprising the polymer coated substrate.

Applying the coating to the cellulose based substrate in foam form is also advantageous as it causes less rewetting of the substrate and therefore allows less hydrophobic and even hydrophilic cellulose based substrates to be used. Thus, in some embodiments, the cellulose based substrate has a water contact angle below 90°, preferably below 80°, more preferably below 70°.

The inventive method comprises applying the aqueous foam to at least one surface of the cellulose based substrate. In some embodiments, the aqueous foam is applied to both surfaces of the cellulose based substrate.

In some embodiments, the aqueous foam is applied to one surface of the cellulose based substrate and an unfoamed polymer coating is applied to the other surface of the cellulose based substrate.

Films comprising high amounts of highly refined cellulose fibers are typically transparent or translucent to visible light. Thus, in some embodiments the cellulose based substrate is transparent or translucent to visible light.

The foam coating of the inventive method improves the barrier properties of the cellulose based substrate, e.g. by blocking pinholes formed in the manufacturing of the cellulose based substrate. Pinholes are microscopic holes that can appear in the web during the forming process, they preferable are in the range of 0.1-100 μm. Examples of reasons for the appearance of pinholes include irregularities in the pulp suspension, e.g. formed by flocculation or re-flocculation of fibrils, rough dewatering fabric, uneven pulp distribution on the wire, or too low a web grammage. Although the method can be used for pinhole free substrates, it is especially advantageous as it allows for the manufacture of films with high barrier properties also from cellulose based substrates having some pinholes. Thus, in some embodiments, the cellulose based substrate comprises more than 2 pinholes/m², preferably more than 8 pinholes/m², and more preferably more than 10 pinholes/m², as measured according to standard EN13676:2001. The measurement involves treating the multilayer film with a coloring solution (e.g. dyestuff E131 Blue in ethanol) and inspecting the surface microscopically. After being subjected to foam coating, the polymer coated cellulose based substrate has less pinholes, preferably at least 50% less pinholes, at least 70% less pinholes, or at least 90% less pinholes, and is more preferably pinhole free. In some embodiments, the polymer coated cellulose based substrate comprises less than 10 pinholes/m², preferably less than 8 pinholes/m², and more preferably less than 2 pinholes/m², as measured according to standard EN13676:2001. It is also possible to analyze the amount of pinholes by other methods, for example visually or optically.

In some embodiments, the cellulose based substrate has a Gurley-Hill value below 40 000 s/100 ml, preferably below 25000 s/100 ml, and more preferably below 10 000 s/100 ml, as measured according to standard ISO 5636/6. The Gurley-Hill value is preferably above 500 s/100 ml, more preferably above 1000 s/100 ml, even more preferably above 1500 s/100 ml and most preferred above 2000 s/100 ml. After being subjected to foam coating, the polymer coated cellulose based substrate has a higher Gurley-Hill value. In some embodiments, the polymer coated cellulose based substrate has a Gurley-Hill value at least 50% higher, at least 75% higher or at least 100% higher than the Gurley-Hill value of the uncoated substrate. In some embodiments, the polymer coated cellulose based substrate has a Gurley-Hill value above 10 000 s/100 ml, preferably above 25000 s/100 ml, and more preferably above 40 000 s/100 ml, as measured according to standard ISO 5636/6.

The polymer coated cellulose based substrate will typically exhibit good resistance to grease and oil. Grease resistance was evaluated by the KIT-test according to standard ISO 16532-2. The test uses a series of mixtures of castor oil, toluene and heptane. As the ratio of oil to solvent is decreased, the viscosity and surface tension also decrease, making successive mixtures more difficult to withstand. The performance is rated by the highest numbered solution which does not darken the sheet after 15 seconds. The highest numbered solution (the most aggressive) that remains on the surface of the paper without causing failure is reported as the “kit rating” (maximum 12). In some embodiments, the KIT value of the cellulose based substrate is below 8 or below 6, as measured according to standard ISO 16532-2. In some embodiments, the KIT value of the polymer coated cellulose based substrate is at least 10, as measured according to standard ISO 16532-2.

The polymer coated cellulose based substrate preferably has high repulpability. In some embodiments, the polymer coated cellulose based substrate exhibits less than 30%, preferably less than 20%, and more preferably less than 10% residues, when tested as a category II material according to the PTS-RH 021/97 test method.

In some embodiments, the polymer coated cellulose based substrate has a water vapor transfer rate (WVTR), measured according to the standard ISO 15106-2/ASTM F1249 at 50% relative humidity and 23° C., of less than 200 g/m²/24 h,

In some embodiments, the polymer coated cellulose based substrate has an oxygen transfer rate (OTR), measured according to the standard ASTM D-3985 at 50% relative humidity and 23° C., of less than 1000 cc/m²/24 h/atm.

In some embodiments, the polymer coated cellulose based substrate has a water vapor transfer rate (WVTR), measured according to the standard ISO 15106-2/ASTM F1249 at 50% relative humidity and 23° C., of less than 200 g/m²/24 h, and an oxygen transfer rate (OTR), measured according to the standard ASTM D-3985 at 50% relative humidity and 23° C., in the range of 50-1000 cc/m²/24 h/atm.

According to a second aspect illustrated herein, there is provided a polymer coated cellulose based substrate useful as a barrier film, obtainable by the inventive method according the first aspect.

The inventive polymer coated cellulose based substrate may preferably be used as a barrier film in a paper or paperboard based packaging material, particularly in liquid packaging board (LPB) for use in the packaging of liquids or liquid containing products.

Thus, according to a second aspect illustrated herein, there is provided a paper or paperboard based packaging material comprising:
a paper or paperboard substrate; and
a polymer coated cellulose based substrate obtainable by the inventive method according the first aspect as a barrier film.

Paper generally refers to a material manufactured in sheets or rolls from the pulp of wood or other fibrous substances comprising cellulose fibers, used for e.g. writing, drawing, or printing on, or as packaging material. Paper can either be bleached or unbleached, coated or uncoated, and produced in a variety of thicknesses, depending on the end-use requirements.

Paperboard generally refers to strong, thick paper or cardboard comprising cellulose fibers used for example as flat substrates, trays, boxes and/or other types of packaging. Paperboard can either be bleached or unbleached, coated or uncoated, and produced in a variety of thicknesses, depending on the end-use requirements.

The polymer coated cellulose based substrate used as a barrier film in the paper or paperboard based packaging material according to the second aspect may be further defined as set out above with reference to the first aspect.

In some embodiments, the paper or paperboard based packaging material has a water vapor transfer rate (WVTR), measured according to the standard ISO 15106-2/ASTM F1249 at 50% relative humidity and 23° C., of less than 200 g/m²/24 h.

In some embodiments, the paper or paperboard based packaging material has an oxygen transfer rate (OTR), measured according to the standard ASTM D-3985 at 50% relative humidity and 23° C., of less than 1000 cc/m²/24 h/atm.

In some embodiments, the paper or paperboard based packaging material has a water vapor transfer rate (WVTR), measured according to the standard ISO 15106-2/ASTM F1249 at 50% relative humidity and 23° C., of less than 200 g/m²/24 h, and an oxygen transfer rate (OTR), measured according to the standard ASTM D-3985 at 50% relative humidity and 23° C., in the range of 50-1000 cc/m²/24 h/atm.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

### EXAMPLES

Two cellulose based substrates with different porosities (Gurley-Hill values) were used. The difference in porosity is due to difference in the size and amount of pin-holes in the substrates—more and larger pin-holes give a lower Gurley-Hill value.

The first substrate (Substrate 1) was a 30 gsm cellulose based substrate made with 70 wt % microfibrillated cellulose and 30 wt % unrefined or slightly refined cellulose fibers. The SR of the pulp mixture was about 90. The first substrate had a Gurley-Hill value of 22500 s/100 ml, as measured according to standard ISO 5636/6. The KIT value of the first substrate was 0, as measured according to standard ISO 16532-2. The water contact angle of the first substrate was below 90 (determined with contact angle meter and determined e.g. after 2 or 5 s).

The second substrate (Substrate 2) was a 30 gsm cellulose based substrate made with 70 wt % microfibrillated cellulose and 30 wt % unrefined or slightly refined cellulose fibers. The SR of the pulp mixture was about 90. The second substrate had a Gurley-Hill value of about 1000-10 000 s/100 ml (average value 6000 s/100 ml), as measured according to standard ISO 5636/6. The KIT value of the first substrate was 0, as measured according to standard ISO 16532-2. The water contact angle of the first substrate was below 90 (determined with Contact angle meter and determined e.g. after 2 or 5 s).

### Comparative Example 1—Solution Coated Substrate 1

The first substrate was coated on one side with an aqueous solution of PVOH (Kuraray POVAL® 6-98, degree of hydrolysis 98.0-98.8 mol %, viscosity 5.0-7.0 mPa-s at 20° C. and 4% aqueous solution) in a short-dwell rod applicator. The PVOH was prepared to a solids content of 17.2 wt %. The application speed was speed 200 m/min. The coated substrate was dried with IR and hot air to a moisture content in the range of 4-6 wt %.

Despite the high solids content, only 2.7 g/m² was obtained with single pass coating. The KIT value of the coated substrate was 5. OTR was too high to be measured. WVTR was 150 g/m²/24 h measured according to the standard ISO 15106-2/ASTM F1249 at 50% relative humidity and 23° C.

Major runnability problems were experienced because of wrinkles formed after coating (indicating heavy wetting of the base sheet).

### Comparative Example 2—Solution Coated Substrate 1

The first substrate was coated in a short-dwell rod applicator like in Comparative example 1 but using a coarser rod. The PVOH was prepared to a solids content of 17.2 wt %. The application speed was 200 m/min. The coated substrate was dried with IR and hot air to a moisture content in the range of 4-6 wt %.

Despite the high solids content, only 4.9 g/m² was obtained with single pass coating. The KIT value of the coated substrate was 5. OTR was too high to be measured. WVTR was 85 g/m²/24 h measured according to the standard ISO 15106-2/ASTM F1249 at 50% relative humidity and 23° C.

Like in Comparative example 1, major runnability problems were experienced because of wrinkles formed after coating (indicating heavy wetting of the base sheet).

### Example 1—Foam Coated Substrate 2

The second substrate was coated on one side with a foamed aqueous solution of PVOH (Kuraray POVAL® 6-98, degree of hydrolysis 9801-98.8 mol %, viscosity 5.0-7.0 mPa-s at 20° C. and 4% aqueous solution) in a puddle size press. The application speed was speed 150 m/min. The aqueous PVOH foam was prepared by foaming an aqueous solution having a PVOH solids content of 17.2 wt %. A commercial foam generator was used to create the foam and the foam was recirculated to make the foam more homogenous. The foaming temperature was above 40° C. but below than 90° C. The coated substrate was dried with IR and hot air to a moisture content in the range of 4-6 wt %.

The obtained coat weight was 5 g/m². The Gurley-Hill value of the coated substrate was 42 300 s/100 ml (max value). The OTR was 240 cc/m²/24 h/atm measured at 23° C. and 50% RH and the WVTR was as low as 10 g/m²/24 h when determined at 23° C. and 50% RH. The KIT value was estimated to above 10.

The foam coating provided very good runnability. No wrinkles were formed after coating, which indicates moderate wetting of the substrate. Surprisingly, no spitting or splashing occurred in the size press nip, which would have been expected with a such high viscosity.

### Example 2—Foam Coated Substrate 2

The second substrate was coated on one side with a foamed aqueous solution of PVOH in a puddle size press like in Example 1 but using a more dilute aqueous PVOH solution. The same PVOH as in Example 1 was used but diluted to 10 wt %. The coater speed was 150 m/min. The coated substrate was dried with IR and hot air to a moisture content in the range of 4-6 wt %.

The obtained G-H was 42 300 s/100 ml (max value) implying high air resistance and a dense substrate.

The foam coating provided very good runnability. No wrinkles were formed after coating, which indicates moderate re-wetting of the substrate. Surprisingly, no spitting or splashing occurred in the size press nip, which would have been expected with a such high viscosity.

1. A method for manufacturing a polymer coated cellulose based substrate, said method comprising the steps of:
a) providing a cellulose based substrate comprising 50-99 wt % highly refined cellulose fibers based on a total dry weight of the cellulose based substrate;
b) preparing an aqueous foam from an aqueous solution of a foam forming polymer;
c) applying the aqueous foam to at least one surface of the cellulose based substrate; and
d) collapsing the aqueous foam to form a polymer coating on the cellulose based substrate.

2. The method according to claim 1, wherein the cellulose based substrate comprises 70-99 wt % highly refined cellulose fibers based on the total dry weight of the cellulose based substrate.

3. The method according to claim 1, wherein the cellulose based substrate is formed from a cellulose furnish having a Schopper-Riegler (SR) value in the range of 70-99.

4. The method according to claim 1, wherein the highly refined cellulose fibers is microfibrillated cellulose (MFC).

5. The method according to claim 1, wherein the cellulose based substrate comprises less than 50 wt % of unrefined or slightly refined cellulose fibers, based on the total dry weight of the cellulose based substrate.

6. The method according to claim 1, wherein the cellulose based substrate has a dry content above 80% by weight.

7. The method according to claim 1, wherein a basis weight of the cellulose based substrate is less than 55 g/m².

8. The method according to claim 1, wherein the cellulose based substrate is transparent or translucent to visible light.

9. (canceled)

10. The method according to claim 1, wherein the cellulose based substrate provided in step a) has a Gurley-Hill value below 40,000 s/100 ml, as measured according to standard ISO 5636/6.

11. (canceled)

12. The method according to claim 1, wherein the polymer coated cellulose based substrate has a Gurley-Hill value above 10,000 s/100 ml, as measured according to standard ISO 5636/6.

13. The method according to claim 1, wherein the foam forming polymer is an amphiphilic polymer selected from a group consisting of: optionally hydrophobically modified polysaccharides, proteins, polyvinyl alcohol (PVOH), partially hydrolyzed polyvinyl acetate (PVOH/Ac), and mixtures thereof.

14. The method according to claim 1, wherein the foam forming polymer is selected from a group consisting of: a polyvinyl alcohol (PVOH), a partially hydrolyzed polyvinyl acetate (PVOH/Ac), and an octenyl succinic anhydride starch (OSA starch).

15. The method according to claim 1, wherein the aqueous foam further comprises a cross-linking agent configured to cross-linking the foam forming polymer.

16. The method according to claim 1, wherein the aqueous foam is prepared from an aqueous solution of the foam forming polymer comprising at least 5 wt %, based on a total weight of the aqueous solution.

17. The method according to claim 1, wherein the aqueous foam has a density of less than 0.8 g/cm³.

18. The method according to claim 1, wherein the aqueous foam has a viscosity in a range of 800-3500 mPas.

19. The method according to claim 1, wherein a thickness of the applied aqueous foam is at least 1 mm before the foam is collapsed.

20. (canceled)

21. The method according to claim 1, wherein the cellulose based substrate is heated before the aqueous foam is applied.

22. The method according to claim 1, wherein said collapsing comprises drying the aqueous foam.

23. (canceled)

24. The method according to claim 1, wherein the polymer coating, when dried, is non-porous.

25. The method according to claim 1, further comprising
e) subjecting the foam forming polymer of the collapsed aqueous foam to crosslinking.

26. The method according to claim 1, wherein a basis weight of the polymer coating is less than 10 g/m².

27. The method according to claim 1, wherein the polymer coated cellulose based substrate has a water vapor transfer rate (WVTR), measured according to the standard ISO 15106-2/ASTM F1249 at 50% relative humidity and 23° C., of less than 200 g/m²/24 h.

28. The method according to claim 1, wherein the polymer coated cellulose based substrate has an oxygen transfer rate (OTR), measured according to the standard ASTM D-3985 at 50% relative humidity and 23° C., of less than 1000 cc/m²/24 h/atm.

29. (canceled)

30. (canceled)

31. (canceled)

32. (canceled)

33. (canceled)
